(19) United States
(12) Patent Application Publication
(10) Pub. No.: US 2002/0198792 A1
(43) Pub. Date: Dec. 26, 2002

(54) Electronic commerce system

(76) Inventor: Shinichi Ban, Sakai-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/178,487

(22) Filed: Jun. 24, 2002

(30) Foreign Application Priority Data
Jun. 25, 2001 (JP) 2001-191103

(51) Int. Cl. G06F 17/60

(52) U.S. Cl. 705/26

(57) ABSTRACT

An electronic commerce system includes computers of users, computers of order-acceptors that are distributors of digital cameras and carry out print services of digital images, a computer of a manager that is a maker of digital cameras and a server, and these elements are connected to each other through networks so as to communicate with each other. The server transmits EC site information so as to receive orders of prints from the users, and sets addition points to the respective distributors in accordance with the sales state of digital cameras in the respective distributors. Then, based upon the addition points, the orders of prints, received through the EC site, are distributed to the respective distributors.

This application is based on application No. 2001-191103 filed in Japan, the contents of which are hereby incorporated by reference.

### BACKGROUND OF THE INVENTION

1. Field of the Invention

The present invention relates to an electronic commerce technique which is provided with a computer that places a trading order for a commodity and an order managing device that receives and manages the trading order.

2. Description of the Background Art

Conventionally, in general, a camera distributor sells cameras and related commodities, and carries out DPE (Development, Printing, Enlargement) services from silver halide films or print services of photograph images picked up by digital cameras.

In recent years, along with the developments in the Internet, the photograph business utilizing the Internet, in which image data is sent through the network to request for prints and the delivery is made through mail, etc. has been widely practiced.

However, with respect to such print services through the Internet, since the business is established comparatively easily by providing an order-receiving system, not only the existing camera distributors, but also digital camera makers themselves have joined the business.

Because of the developments of this system, the makers have come to enter businesses related to outputs of images that the distributors have taken in charge, and this might cause the distributors to lose existing profits.

### SUMMARY OF THE INVENTION

The present invention is directed to an electronic commerce system.

According to the present invention, the electronic commerce system which has a group of information processing elements includes a computer for placing orders of objective commodities and an order managing device for retrieving and managing the orders. The group of information processing elements are mutually connected through a network. The group of information processing elements includes (a) a sales managing element for managing sales information of reference commodities different from the objective commodities in a plurality of distributors selling the reference commodities, (b) a settling element for setting allocation of orders among the plurality of distributors in accordance with the sales information of the reference commodities, and (c) a sharing element which shares respective orders of the objective commodities received by the order managing device among the plurality of distributors based upon the allocation. Therefore, in the case when a maker, which owns an EC (Electric Commerce) site, etc., receives orders of a commodity that distributors deal with, the maker is allowed to distribute the received orders to the respective distributors while alleviating repulsive feelings from the distributors.

According to a preferred embodiment of the present invention, in this electronic commerce system, the reference commodities includes plural kinds of commodities, and the setting element is operable to set the allocation at different weights with respect to the plural kinds of commodities. Therefore, the amount of distribution is set with the sales state of each of the commodities of a plurality of kinds being taken into consideration.

Moreover, the present invention is also directed to an order receiving and placing system for commodities, a received order managing device, a recording medium and an electronic commerce method.

Therefore, an object of the present invention is to provide an electronic commerce system that is formed based upon the fact that new entry entrepreneurs in the business which do not have printing facilities tend to consign printing jobs to the existing distributors having the corresponding facilities, and is beneficial to both of the makers and distributors.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view that shows a schematic construction of an electronic commerce system in accordance with a preferred embodiment of the present invention.

FIG. 2 is a view that explains changes in a screen displayed by the user's computer.

FIG. 3 is a view that shows a user log-in screen.

FIG. 4 is a view that shows a user registering screen.

FIG. 5 is a view that shows a photograph image box screen.

FIG. 6 is a view that shows an uploading screen of an image.

FIG. 7 is a view that shows a print ordering screen.

FIG. 8 is a view that shows a settlement screen.

FIG. 9 is a view that explains changes in a screen displayed by an manager's computer.

FIG. 10 is a view that shows an manager's log-in screen.

FIG. 11 is a view that shows a print order managing screen.

FIG. 12 is a view that shows a product-based point gravity setting screen.

FIG. 13 is a view that shows a dialogue box, “product-based point gravity setting: addition”.

FIG. 14 is a view that shows a dialogue box, “product-based point gravity setting: revision”.

FIG. 15 is a view that shows a print-shop managing screen.

FIG. 16 is a view that shows a dialogue box, “print-shop managing: addition”.

FIG. 17 is a view that shows a dialogue box, “print-shop managing: revision”.

FIG. 18 is a view that shows a print progress managing screen.

FIG. 19 is a view that shows a dialogue box, “customer information”.

FIG. 20 is a view that shows a dialogue box, “switching to another shop”.

FIG. 21 is a view that explains distributor-based point accumulation.

FIGS. 22A to 22E are views that explain point distributions based upon point shares.

FIG. 23 is a flowchart that explains the operation of distributions of print jobs.

FIG. 24 is a flowchart that explains point calculations of the entire distributors (except for special agents).

FIG. 25 is a flowchart that explains the point calculations of distributors.

FIG. 26 is a flowchart that explains the calculations of actual assigned number of sheets to a distributor (except for special agents) that has the n-th number of point shares.

FIG. 27 is a flowchart that explains a combining process of orders.

FIG. 28 is a view that explains a combining process of orders.

FIG. 29 is a view that explains changes in a screen displayed by a computer of an order acceptor.

FIG. 30 is a view that shows an order acceptor's log-in screen.

FIG. 31 is a view that shows a print order-receiving screen.

FIG. 32 is a view that shows a dialogue box, “customer information”.

### DESCRIPTION OF THE PREFERRED EMBODIMENTS

### Essential Construction of Electronic Commerce System

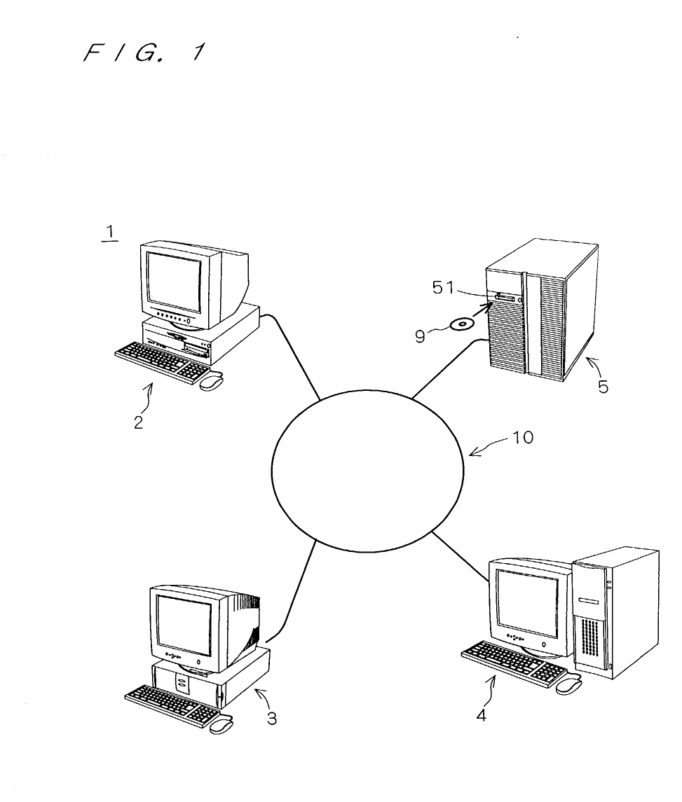

FIG. 1 is a view that shows a schematic construction of an electronic commerce system 1 in accordance with a preferred embodiment of the present invention. This electronic commerce system 1 shows one example of a system in which prints of digital images are ordered by each of users (ordering persons) through the Internet and a maker which have received the orders distributes these,orders to distributors (order acceptors), which sell the maker's digital cameras and deal with silver halide prints.

Electronic commerce system 1 is constituted by a computer 2 that the user owns, a computer 3 that the order acceptor owns, a computer 4 that a manager of a maker of digital cameras, etc. has and a server 5 that are mutually connected to a network (for example, the Internet) 10 to form a group of information processing elements. In fact, a number of computers 2 of the users and a number of computers of the order acceptors 3 which are connected to the network 10 may be placed; however, for convenience of view, these are respectively limited to one in the drawings.

Each of computers 2, 3, 4 is achieved by a generally-used computer having devices such as a memory, a CPU, a magnetic disk, a display and a mouse. This computer 2 functions as a device that is used by the user to place a trading order of prints relating to image data.

Server 5, which is provided with a memory, a CPU, a magnetic disk, etc., functions as a received-order managing device that transmits information of Web Photo Sites that are EC sites, and receives and manages orders from the users. Moreover, server 5 has a drive 51 to which a recording medium 9, such as an optical disk, is attached so that program data recorded in recording medium 9 is stored in a memory of server 5. Thus, the programs stored therein are reflected to the operation of server 5.

### Operation of Electronic Commerce System 1

In electronic commerce system 1 having the above-mentioned construction, the following description will discuss operations of the user, the manager and the order acceptor which are transmitted from server 5 with respect to Web Photo Sites.

### User Operation

The user carries out inputting operations on computer 2 to access the Web Photo Site of server 5 so as to order silver halide prints of digital images.

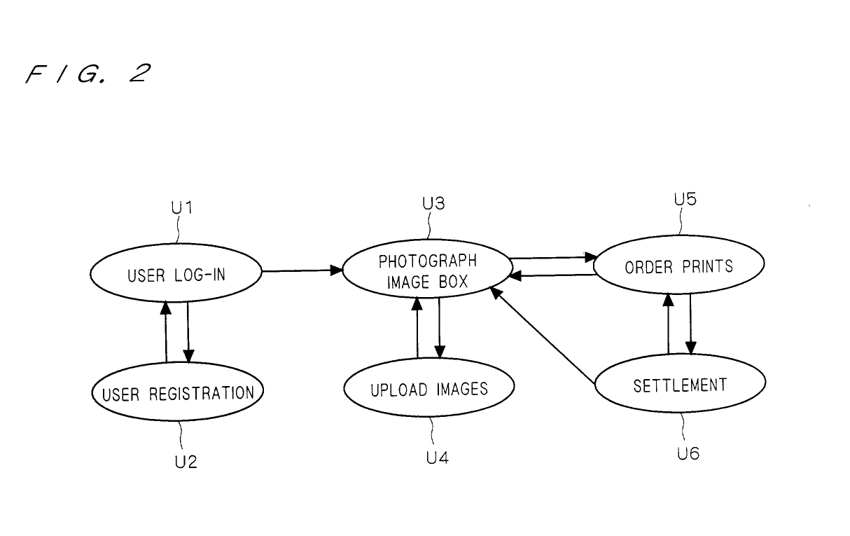

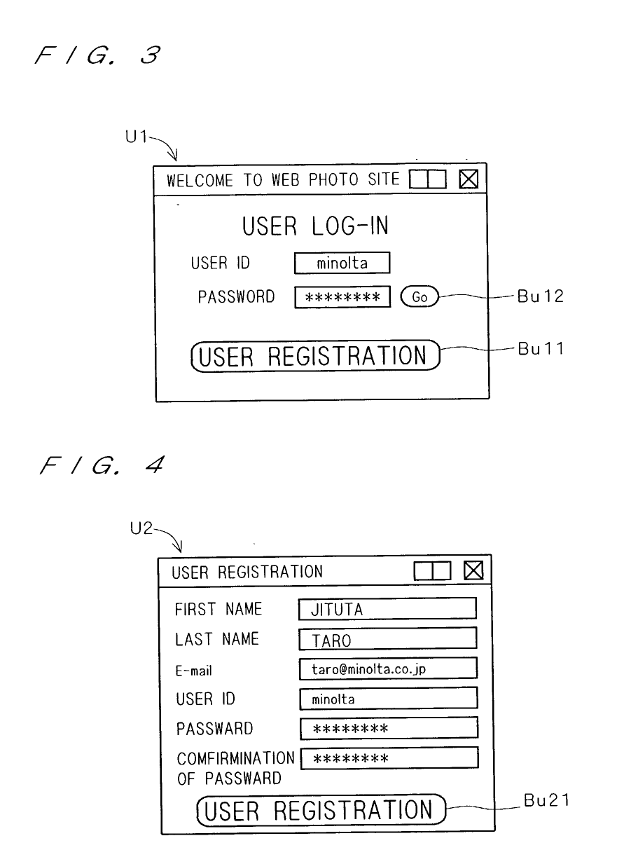

FIG. 2 is a view that explains changes in a screen displayed on computer 2 of the user. The following description will discuss respective screens U1 to U6 displayed on computer 2.

### User Log-in Screen

FIG. 3 is a view that shows a user log-in screen U1.

Upon inputting a user URL (Uniform Resource Locator) through a Web browser in computer 2 and accessing the Web Photo Site, the initial screen requests the user to input the user ID and password.

In the case of the first access to the Web Photo Site, since no user ID has been acquired, a “user registering” button Bu11 is selected and the screen changes to a user registering screen U2 (FIG. 4).

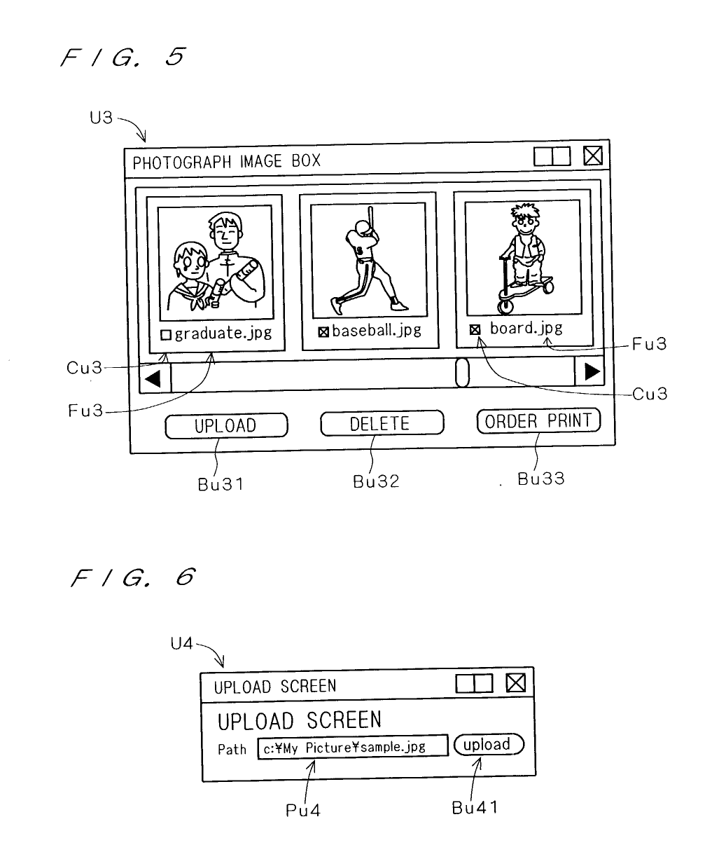

Here, when the user has already acquired the user ID, he or she inputs the user ID and password into the corresponding frames, and selects a “Go” button Bu12; thus, the screen changes to a photograph image box screen U3 (FIG. 5).

(2) User Registering Screen

FIG. 4 is a view that shows user registering screen U2.

The user inputs the family name, name, E-mail address, desired user ID and password into the corresponding frames in the user registering screen, and selects a “user registering” button Bu21, thereby completing the user registration. When the user registration has been completed successfully, the screen changes to photograph image box screen U3 (FIG. 5).

Here, in the case when the same user ID has already been registered, after notification of this fact, user registering screen U2 is again displayed with a blank space only in the “user ID” frame to make a request for an input of a new user ID.

(3) Photograph Image Box Screen

FIG. 5 is a view that shows photograph image box screen U3.

In photograph image box screen U3, images that the user has uploaded before are displayed as thumbnail images. Moreover, a file name Fu3 and a check box Cu3 are displayed below each of the thumbnail images.

Upon selection of an “upload” button Bu31, the screen changes to an upload screen U4 (FIG. 6).

Moreover, when a “deletion” button Bu32 is selected, those images having checks in their check boxes Cu3 are deleted from the Web Photo Site.

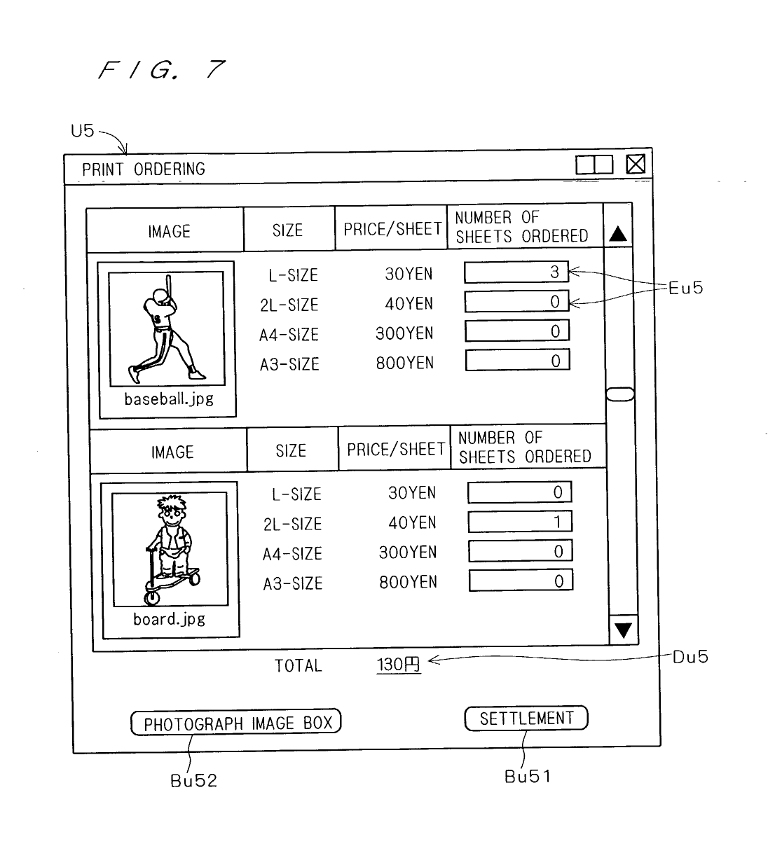

Upon selection of a “print order” button Bu33, the screen changes to a print order screen U5 (FIG. 7) that is used for ordering silver halide prints with respect to those images having checks in the check boxes Cu3.

(4) Upload Screen of Images

FIG. 6 is a view that shows an image upload screen U4.

A path to an image to be uploaded to the Web Photo Site is inputted to a path input frame Pu4.

Upon selection of an “Upload” button Bu41, those image files specified in path input frame Pu4 are transferred to the Web Photo Site. Upon completion of this transferring process, the screen changes to photograph image box screen U3 (FIG. 5), thereby displaying the images uploaded by the user as thumbnail images with the newly transferred images added thereto.

(5) Print Order Screen

FIG. 7 is a view that shows a print order screen U5.

Here, in the initial screen, a list of images that have been checked in photograph image box screen U3 and selected are displayed as a list. In this list, the size and unit price of silver halide print are displayed on the right side of each image, and the user inputs the number of ordering prints to an edit box Eu5. Then, each time the number of ordering prints is altered, display Du5 of the sum total is updated.

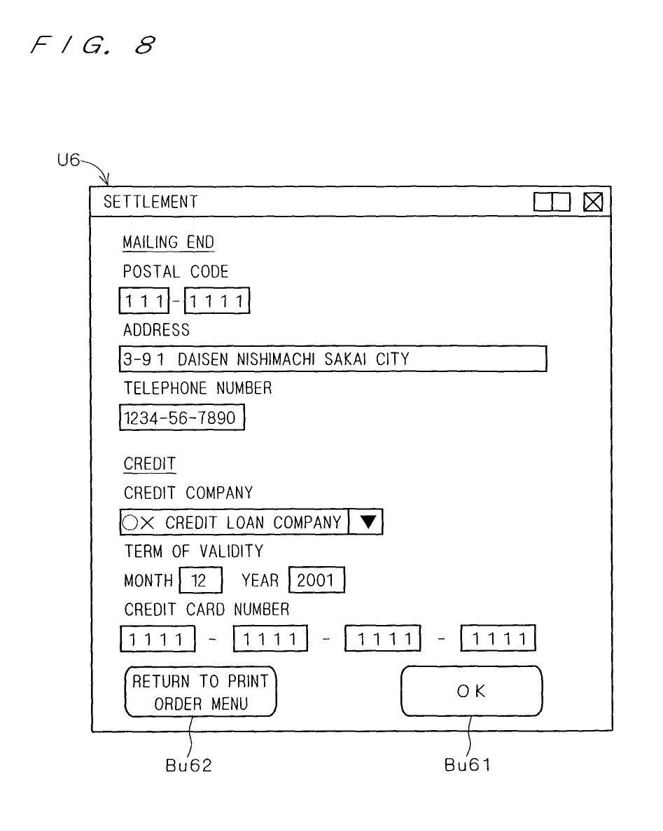

Upon completion of the ordering process, the user selects a “settlement” button Bu51, and the screen changes to a settlement screen U6 (FIG. 8).

If the user is not satisfied with the order, he or she can press “photograph image box” button Bu52 to return to photograph image box screen U3 (FIG. 5).

(6) Settlement Screen

FIG. 8 is a view that shows settlement screen U6.

The user inputs the postal code number in a “postal code number” frame, the address in an “address” frame and the phone number in a “telephone number” frame as information relating to the mailing end of silver halide prints.

Then, for settlement on credit for print payment, the user selects a credit company to be used for the settlement from a “credit company” combo box, and inputs the term of validity of the credit card in a “term of validity” frame and the credit card number in a “credit card number” frame.

After confirming the inputted data, the user selects “OK” button Bu61 so that the settlement information is transmitted to the Web Photo Site, thereby completing the print ordering process, and the screen changes to photograph image box screen U3 (FIG. 5).

When the user attempts to terminate the settlement, he or she selects a “return to print ordering” button Bu62 to return to print ordering screen U5 (FIG. 7).

### Operations of Manager

The manager carries out inputting operations on computer 4 to access the Web Photo Site of server 5 so as to manage orders of silver halide prints received from the users.

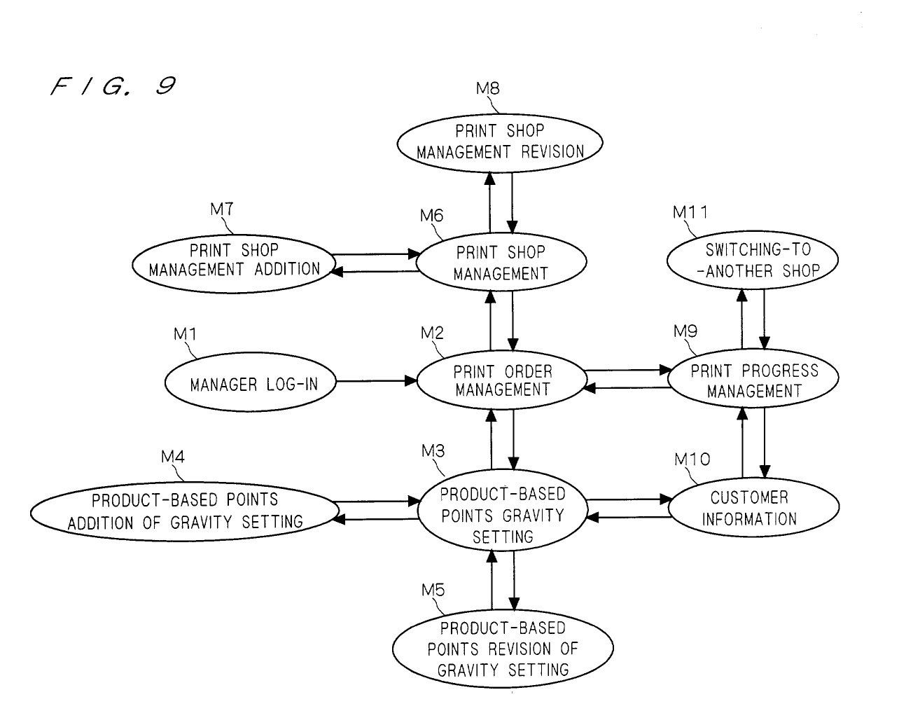

FIG. 9 is a view that explains changes in the screen displayed on computer 4 of the manager. The following description will discuss respective screens M1 to M11 displayed on computer 2.

(1) Manager Log-in Screen

FIG. 10 is a view that shows an manager log-in screen M1.

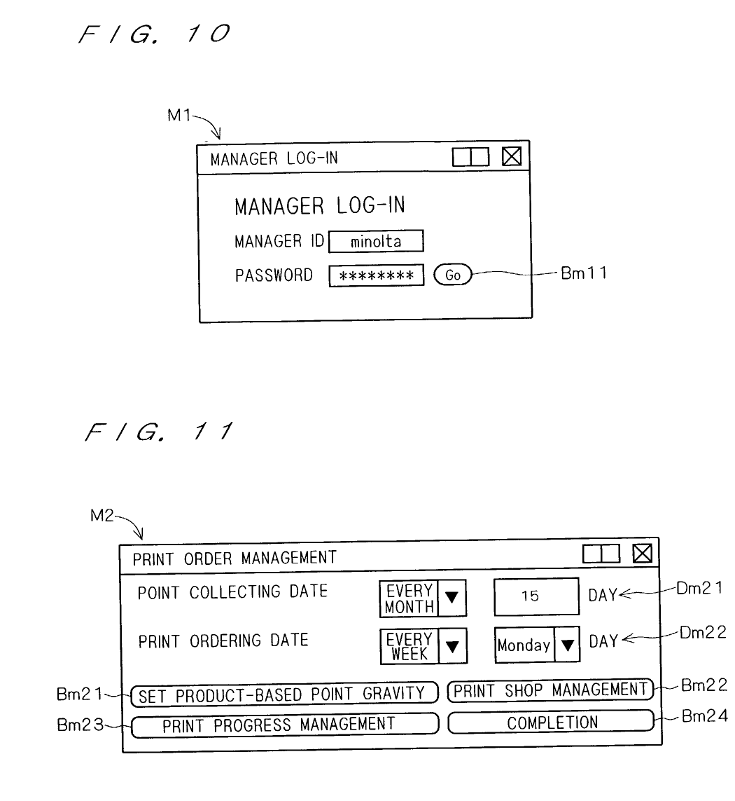

When the manager inputs a print manager URL to access the Web Photo Site through a Web browser of computer 4, the initial screen requests inputs of the manager ID and password. When, after inputting the manager ID and password, the manager selects a “Go” button Bm11, the screen changes to a print ordering screen M2 (FIG. 11).

(2) Print Order Managing Screen

FIG. 11 is a view that shows a print order managing screen M2.

Print order managing screen M2 provides a setting for distributing print orders to distributors.

“Point collecting date” Dm21 sets time intervals in which points, calculated based upon sales proceeds of each of the distributors, are collected.

“Print ordering date” Dm22 sets time intervals in which prints are ordered for the respective distributors in accordance with the points.

Upon selection of “product-based point-gravity setting” button Bm21, the screen changes to a product-based point-gravity setting screen M3 (FIG. 12).

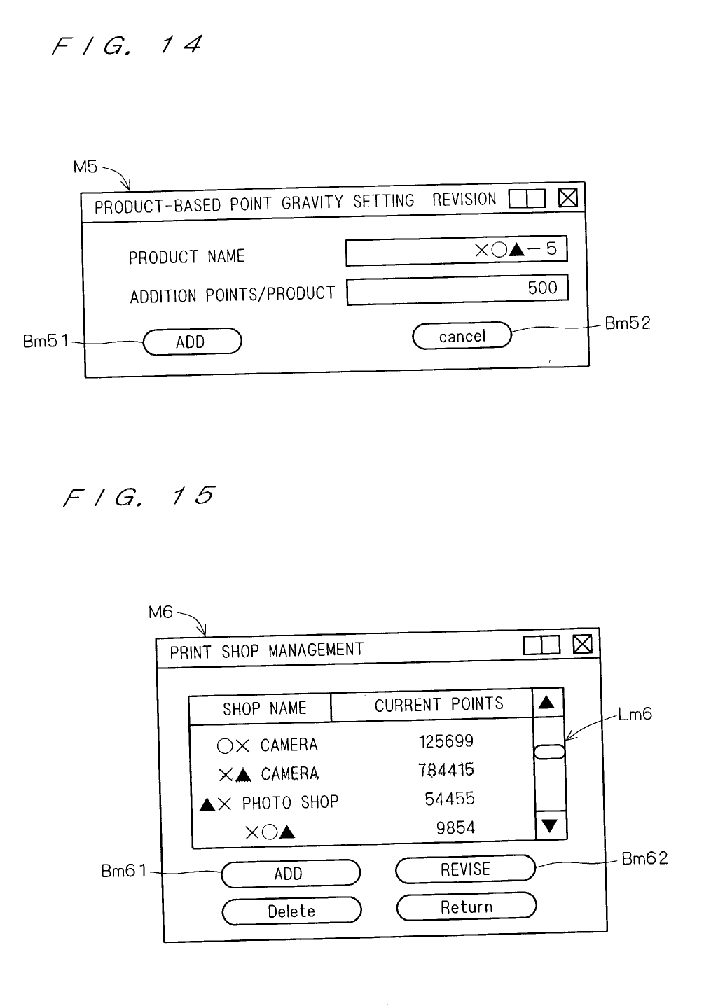

Upon selection of a “print shop managing” button Bm22, the screen changes to a print shop managing screen M6 (FIG. 15).

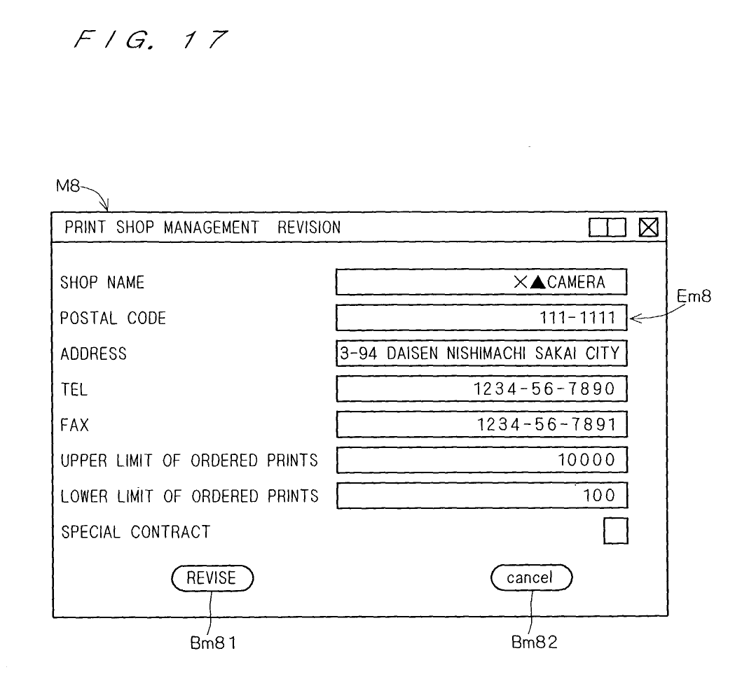

Upon selection of a “print progress managing” button Bm23, the screen changes to a print progress managing screen M9 (FIG. 18).

Upon selection of a “completion” button Bm24, print order managing screen M2 is completed.

(3) Product Point Gravity Setting Screen

FIG. 12 is a view that shows a product-based point gravity setting screen M3.

Product-based point gravity setting screen M3 provides a setting for a calculation method of points of distributors based on which the amounts of prints to be distributed are determined. The points of distributors are calculated as the sum total of (the number of products that have been sold between the point collecting dates)×(addition of points/product) with respect to each of the products.

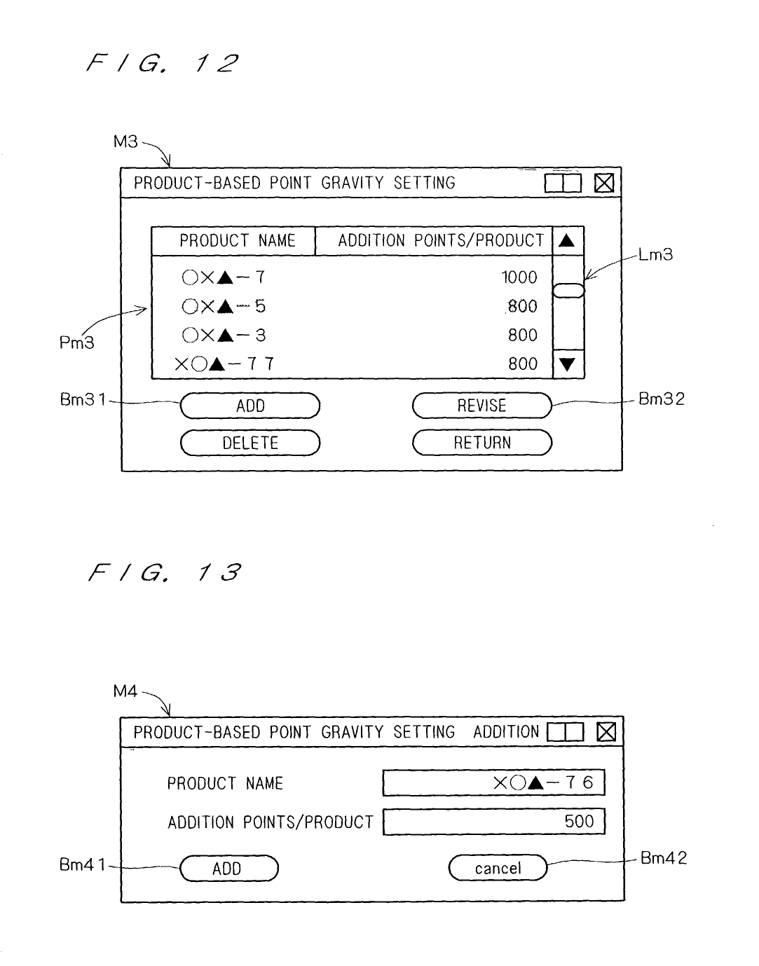

Upon selection of “add” button Bm31, a “product-based point gravity setting: addition” dialogue box M4 (FIG. 13) is displayed. Here, when, after inputting a product name and an added point/product into the corresponding frames, an “add” button Bm41 of the dialogue box is selected, the product to be added by points is added to product-based point gravity-setting screen M3. Moreover, when a “Cancel” button Bm42 is selected, “product-based point gravity setting: addition” dialogue box M4 is completed without adding any product to the product-based point gravity setting screen.

Upon selection of a “revise” button Bm32 (FIG. 12), “product-based point gravity setting: revision” dialogue box M5 (FIG. 14) is displayed with respect to products Pm3 (half-tone dot-meshing portions) selected in a list Lm3 of product-based point gravity setting screen M3. Here, when, after inputting a revised value of “addition points/product” to the corresponding frame, a “revise” button Bm51 in dialogue box M5 is selected, the “addition points/product” of the corresponding product in product-based point gravity screen M3 is revised. Moreover, when “Cancel” button Bm52 is selected, “product-based point gravity setting: revision” dialogue box M5 is completed without revising “addition points/product” in product-based point gravity setting screen M3.

(4) Print Shop Managing Screen

FIG. 15 is a view that shows a print shop managing screen M6.

In print shop managing screen M6, the distributors for receiving orders of prints and the current acquired points are displayed as a list Lm6.

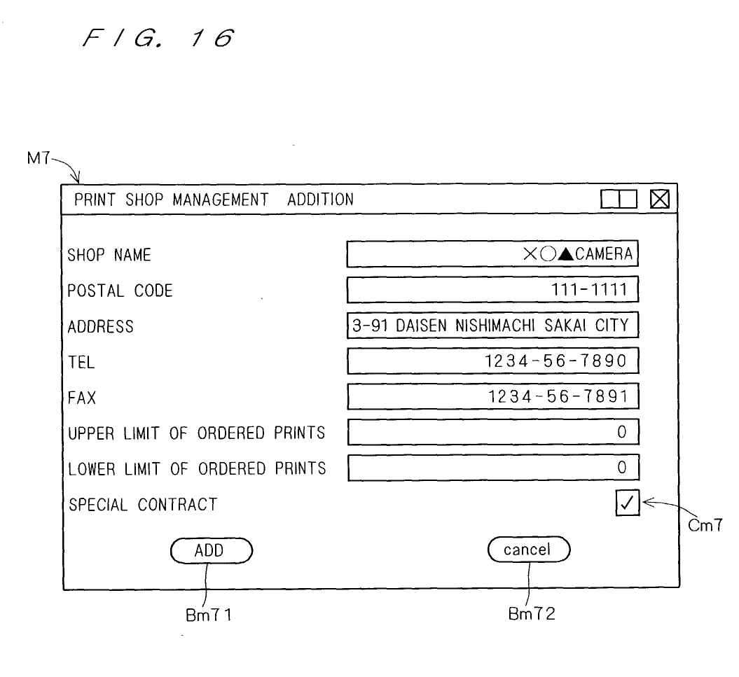

Upon selection of “add” button Bm61, a “print shop management: addition” dialogue box M7 (FIG. 16) is displayed. Here, when a shop name, etc. are inputted to the corresponding frames and “add” button Bm71 is selected, the corresponding distributor for receiving orders of prints is added to the print managing screen. Moreover, when “Cancel” button Bm72 is selected, dialogue box M7 is completed without adding any distributor. Here, “special contract” check box Cm7 is used for checking those distributors having a special contract whose upper limit and lower limit of received orders are not specifically determined. These special agent distributors carry out a fractional number of processes of print orders, as will be described later.

Upon selection of “revise” button Bm62 (FIG. 15), the screen changes to a “print shop management: revision” dialogue box M8 (FIG. 17) in which information of those distributors selected in list Lm6 is displayed in an edit box Em8. When, after revising desired items in edit box Em8, a “revise” button Bm81 is selected, the display of print shop management screen M6 is updated with the corresponding items having been revised. Moreover, when a “cancel” button Bm82 is selected, dialogue box M8 is completed without revising any items in edit box Em8.

(5) Print Progress Managing Screen

FIG. 18 is a view that shows a print progress managing screen M9.

Print progress managing screen M9 displays print jobs that have delivery delays on a list Lm9.

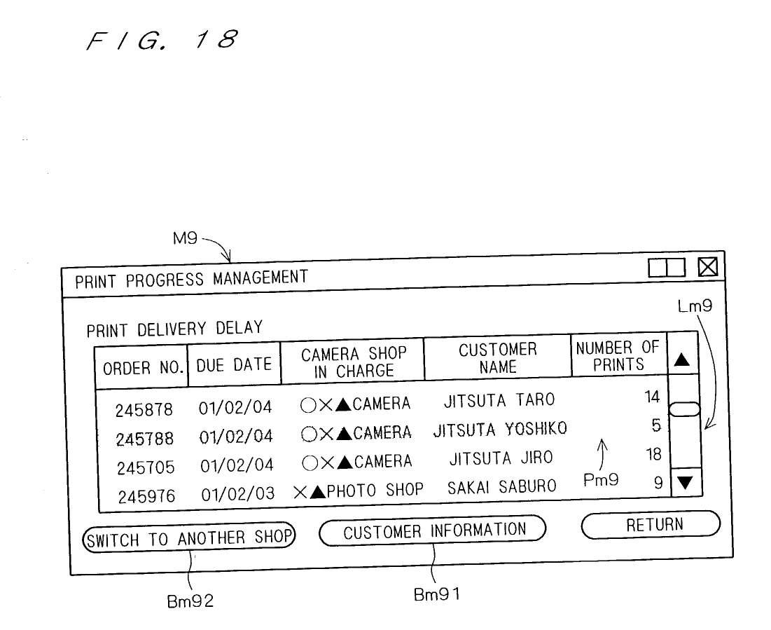

When, after selecting a print job Pm9 (half-tone meshing portion) from this list Lm9, a “customer information” button Bm91 is selected, a “customer information” dialogue box M10 (FIG. 19) appears to display customer information. When “return” button Bm101 in this dialogue box is selected, dialogue box M10 is deleted to return to print progress management screen M9.

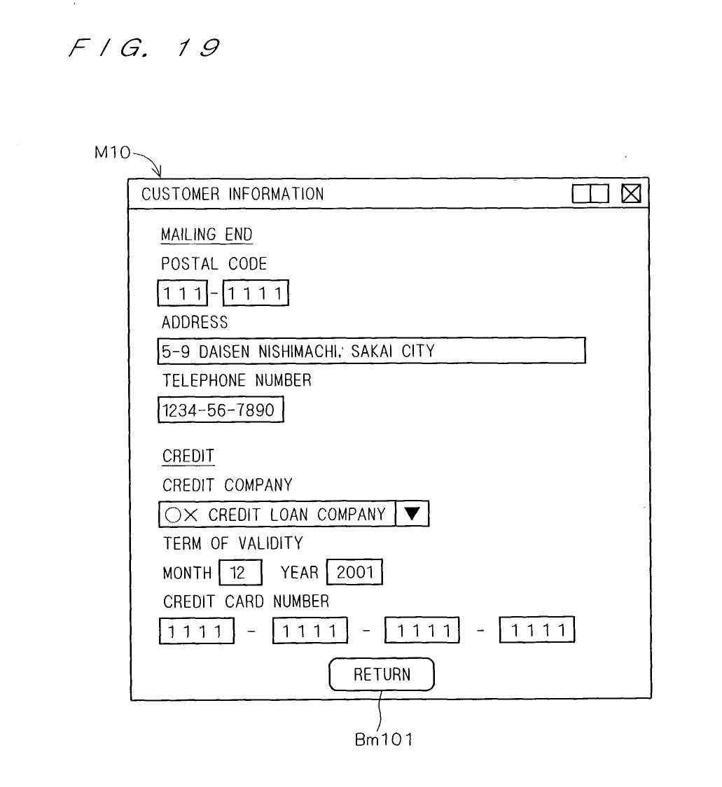

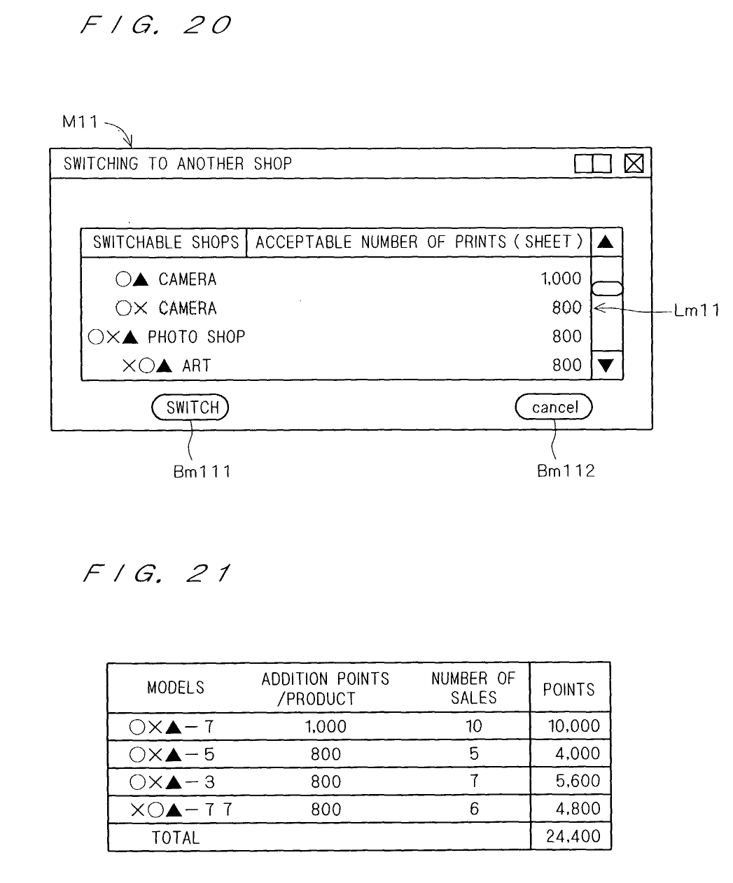

When, after selecting print jog from list Lm9, a “switching-to-another shop” button Bm92 is selected, a “switching-to-another shop” dialogue box M11 (FIG. 20) appears, thereby displaying “switchable shops” that are replaceable shops for the print jobs on a list Lm11.

An algorithm used for determining switchable shops is the same as that used for automatic distribution of print jobs, which will be described later. When a “switch” button Bm111 in dialogue box M11 is selected, the shop assigned to the corresponding print job is altered. Since then, dialogue box M11 is deleted and print progress managing screen M9 is updated. Moreover, when “Cancel” button Bm112 is selected, dialogue box M11 is deleted to return to print progress managing screen M9.

Based upon information set in the above-mentioned screens M1 to M11, the Web Photo Site of server 5 automatically distributes or sharing print jobs. The following description will discuss this automatic distributing operation.

First, sales information of digital cameras as reference commodities in each of the distributors is obtained so that in managing server 5, points collection is carried out on each of the distributors. More specifically, as shown in FIG. 21, the sum total of model-based number of products sold×(addition points/product) in a distributor is set as the acquired point of the distributor. This point is calculated on a point collecting date basis that is set in print managing screen M2. In this manner, based upon sales of digital cameras, a weighting process is carried out on each of digital cameras of a plurality of types so that the amounts of print distribution or allocation of print orders, which will be described below, are determined in the form of allocation table.

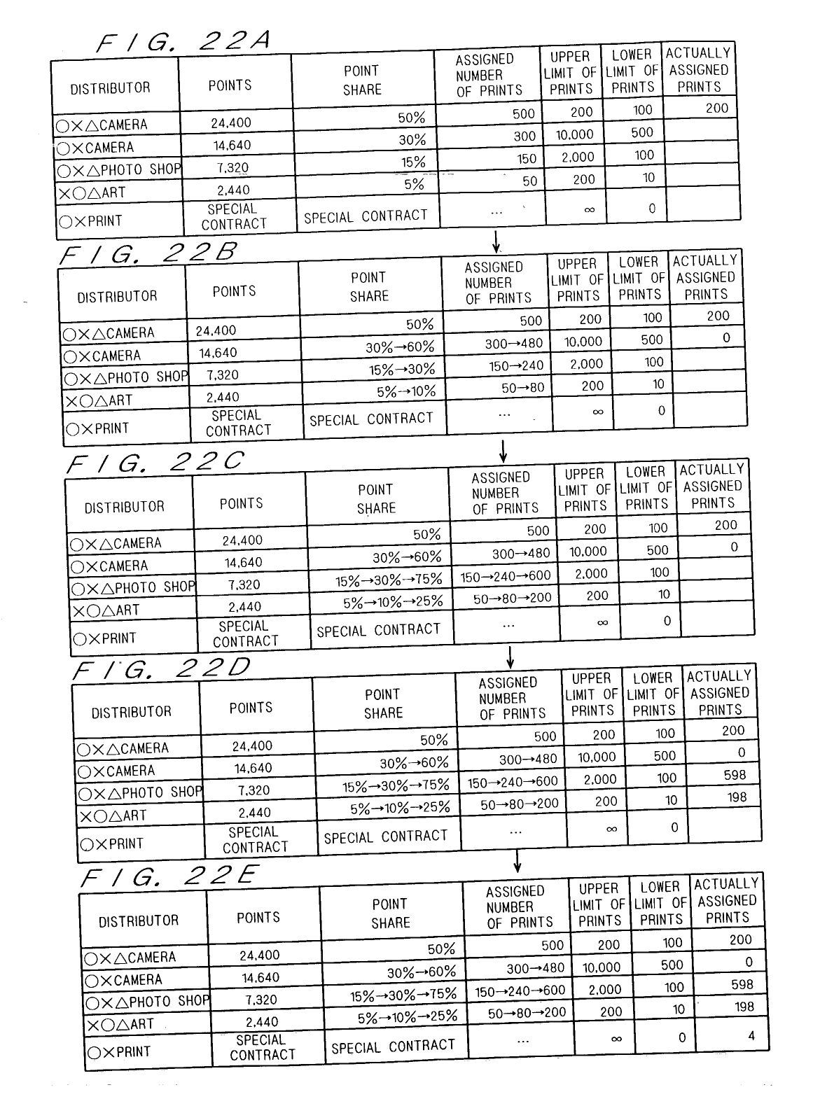

Next, a point distribution process is carried out based upon point shares. More specifically, prints are distributed on a print-ordering date basis set in print managing screen M2, and orders are given to the distributors. As to how to determine the amounts of print distribution, referring to specific examples shown in FIGS. 22A to 22E, explanations will be given. In these specific examples, 1000 prints are shared and distributed as objective commodities.

As shown in FIG. 22A, the amounts of print distribution are determined, starting from the distributor having the top of point shares. Here, although the number of prints to be assigned is 500 when calculated based upon the point shares, since the upper limit of prints of ◯×Δ camera shop is 200 prints, the number of prints to be actually assigned is limited to 200 prints.

Next, as shown in FIG. 22B, the number of the rest of prints is 800 after 200 prints have been actually assigned to ◯×Δ camera shop; therefore, these 800 prints are distributed to the rest of distributors except for ◯×Δ camera shop based upon the respective point shares.

Moreover, as shown in FIG. 22C, in ◯× camera shop, the number of prints assigned thereto is smaller than the lower limit of prints, that is, 500 prints, so that the actual number of prints to be assigned is set to 0, and unassigned 800 prints are distributed to the rest of distributors.

Then, as shown in FIG. 22D, with respect to the print distribution, since the distribution is made each time an order is received from each of the users, in some cases, it is not possible to exactly distribute the prints with numbers of assigned prints. In such a case, the combination of orders is adjusted so that the prints are distributed to the respective distributors in a manner so as to minimize the gap between the number of prints to be assigned and the actual number of prints that have been assigned.

Lastly, as shown in FIG. 22E, since those distributors of special agents do not have any specific upper limit (a maximum limit) and lower limit (or minimum limit) of prints so as to deal with a fractional number of ordered prints, they process a fractional number of ordered prints, or prints the orders of which have not been accepted by the other distributors are assigned to them. More specifically, four prints, which are a fractional number of prints, are actually assigned to the ◯× print shop that is a special agent. In this manner, by maintaining distributors that carry out printing jobs that have not accepted by any other distributors, it is possible to carry out the print distribution smoothly.

Since the above-mentioned distributing operation of server 5 makes it possible to set the amounts of distribution of ordered prints to the respective distributors in accordance with sales information of digital cameras, the ordered prints, received by server 5, can be smoothly distributed to the respective distributors based upon the amounts of distribution of ordered prints.

Referring to a flowchart, the above-mentioned automatic distribution of print jobs will be explained below.

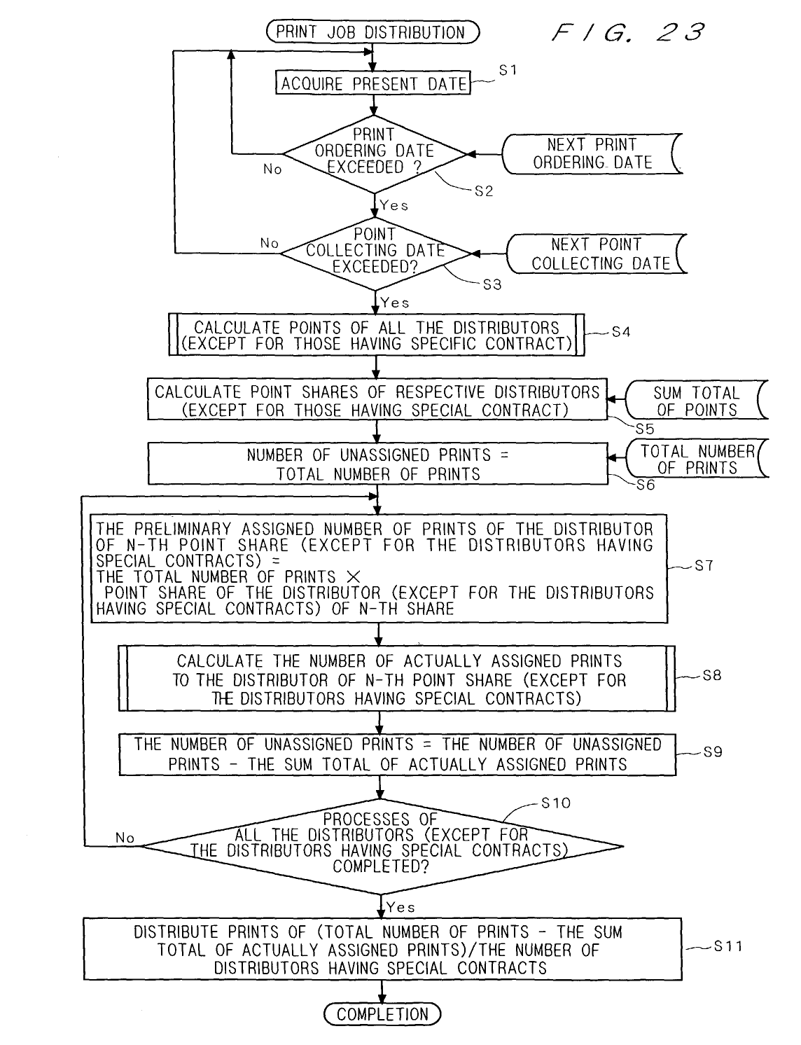

FIG. 23 is a flowchart that explains the operation of the distribution of print jobs.

At step S1, the present date is acquired. This process is made by acquiring the date information from the time-counting function of server 5.

At step S2, it is determined whether or not the date acquired at step S1 has exceeded a print ordering date. This print ordering date is obtained from the next ordering date information set at print order managing screen M2. Here, if the print ordering date has been exceeded, the sequence proceeds to step S3, and if not, the sequence returns to step S1.

At step S3, it is determined whether or not the date acquired at step S1 has exceeded a point collecting date. This point collecting date is obtained from the next point collecting date information set at print order managing screen M2. Here, if the point collecting date has been exceeded, the sequence proceeds to step S4, and if not, the sequence returns to step S1.

At step S4, the sum total of points of all the distributors except for the distributors of special agents is calculated (which will be described later).

At step S5, based upon the sum total of points calculated at step S4, the point shares of the respective distributors except for the distributors of special agents are calculated.

At step S6, the number of unassigned prints is set to the total number of prints ordered from the users.

At step S8, the number corresponding to (total number of prints)×(point share of the distributor (except for the special agents) of n-th share) is substituted to the preliminary assigned number of prints of the distributor of n-th point share (except for the special agents)(which will be described later).

At step S8, the actual number of prints assigned to the distributor of n-th point share (except for the distributors of the special agents) is calculated.

At step S9, the number obtained by subtracting the sum total of the actually assigned number of prints set at step S9 from the number of unassigned prints is used to update the number of unassigned prints.

At step S10, it is determined whether or not the processes for all the distributors (except for the distributors of the special agents) have been completed. Here, if the processes have been completed, the sequence proceeds to step S11, and if not, the sequence returns to step S7.

At step S11, the number of prints obtained by dividing (the total number of ordered prints−the sum total of actually assigned prints) by the number of the distributors of the special agents is distributed to the distributors of the special agents. Consequently, a fractional number of prints that have not been assigned are evenly distributed to those distributors of the special agents.

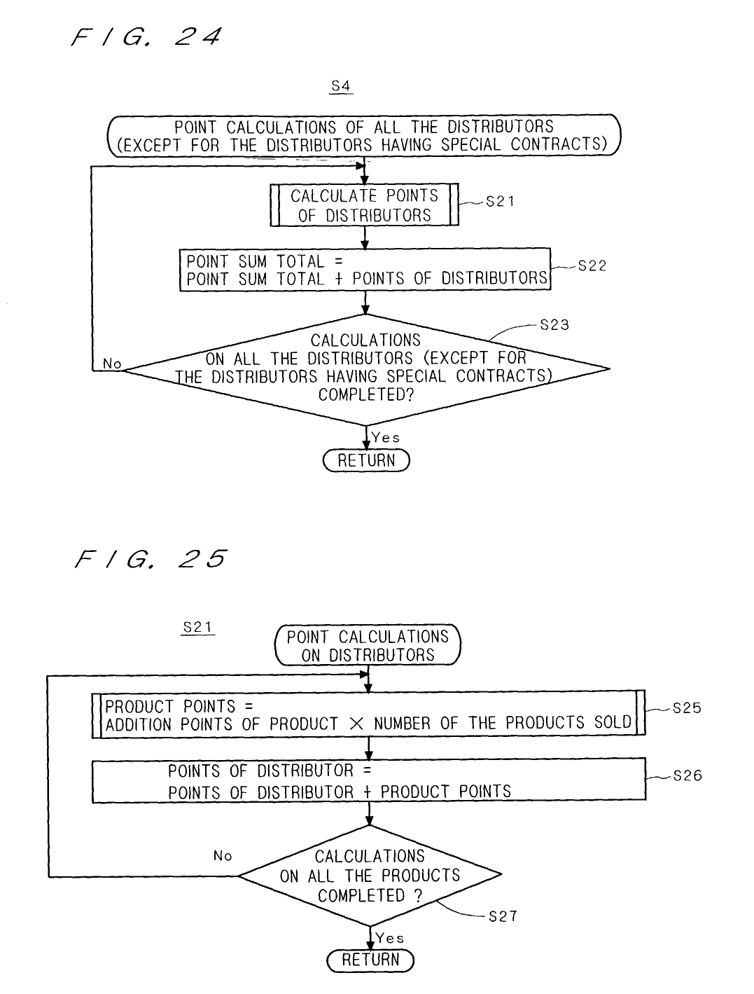

FIG. 24 is a flowchart that explains calculations of points of the entire distributors (except for the distributors of the special agents) relating to the above-mentioned step S4.

First, after substituting 0 to the sum total of points, calculations of points are carried out on each of the distributors, which will be described later (step S21).

At step S22, the sum total of points is updated by a value obtained by adding the points of the distributors to the sum total of points.

At step S23, it is determined whether or not all the calculations except for the distributors of the special agents have been completed, and if the calculations have been completed, the sequence proceeds to step S5, and if the calculations have not been completed, the sequence returns to step S21.

FIG. 25 is a flowchart that explains the point calculations of the distributors relating to step S21.

First, after substituting 0 to the point of each distributor, a value obtained by multiplying addition points to products by the number of products sold is substituted to the product point (step S25).

At step S26, the points of each distributor is updated by a value obtained by adding the product points calculated at step S25 to the points of each distributor.

At step S27, it is determined whether or not the calculations of the entire products have been completed. If the calculations have been completed, the sequence proceeds to step S22, while, if the calculations have not been completed, the sequence returns to step S25.

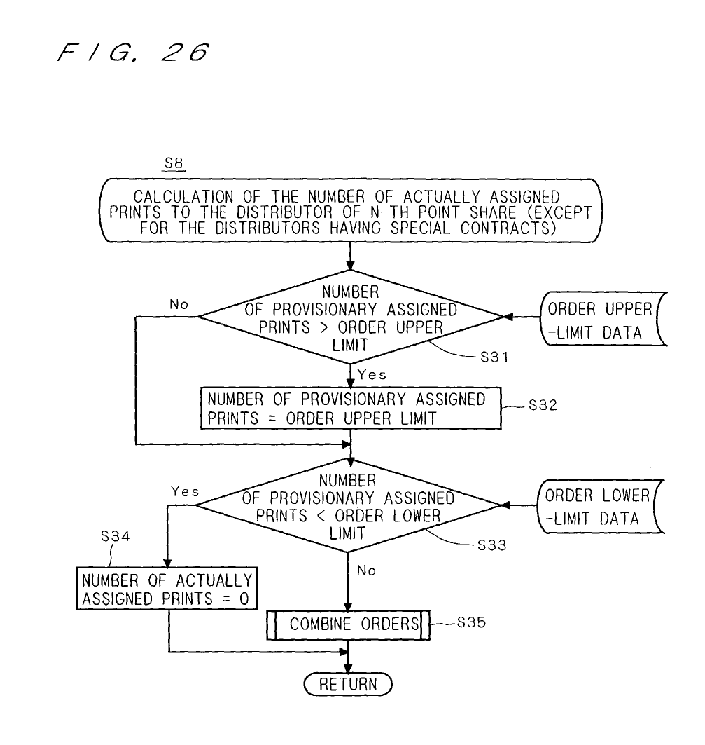

FIG. 26 is a flowchart that explains the calculations of the actual number of assigned prints to a distributor (except for the distributors of the special agents) having the n-th point share, which relates to the above-mentioned step S8.

At step S31, it is determined whether or not the provisionary assigned number of prints is greater than the upper limit of ordered prints of a distributor. The upper limit of ordered prints of this distributor is obtained from the upper limit data of ordered prints that has been set at print shop managing screen M6. Here, if the provisionary assigned number of prints is greater than the upper limit of ordered prints, the sequence proceeds to step S32, while, if not, the sequence proceeds to step S33.

At step S32, since the provisionary assigned number of prints exceeds the upper limit of ordered prints, the upper limit of ordered prints of the distributor is substituted to the provisionary assigned number of prints. With this method, in the case when the number of distribution of ordered prints is greater than the upper limit of ordered prints, the number of distribution of ordered prints to the corresponding distributor is limited to the upper limit of ordered prints, it is possible to carry out the distribution by taking the situation of each distributor into consideration.

At step S33, it is determined whether or not the provisionary assigned number of prints is smaller than the lower limit of ordered prints of a distributor. The lower limit of ordered prints of this distributor is obtained from the lower limit data of ordered prints that has been set at print shop managing screen M6. Here, if the provisionary assigned number of prints is smaller than the lower limit of ordered prints, the sequence proceeds to step S34, while, if not, the sequence proceeds to step S35.

At step S34, since the provisionary assigned number of prints is smaller than the lower limit of ordered prints, 0 is substituted to the actual number of assigned prints of the distributor. With this arrangement, in the case when the assigned number of prints is smaller than the lower limit of ordered prints, the distribution to the corresponding distributor is inhibited; thus, it is possible to carry out the distribution by taking the situation of each distributor into consideration.

At step S35, a combining process of orders is carried out (which will be described later).

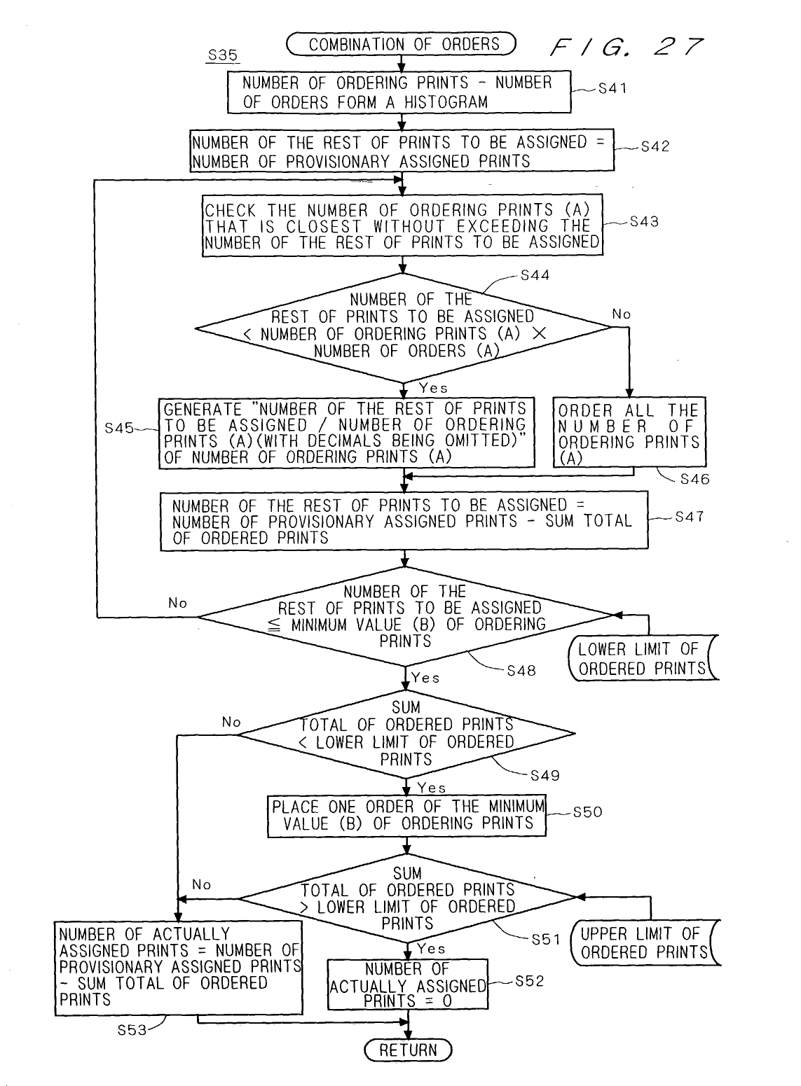

FIG. 27 is a flow chart that explains the combining process of orders relating to step S35.

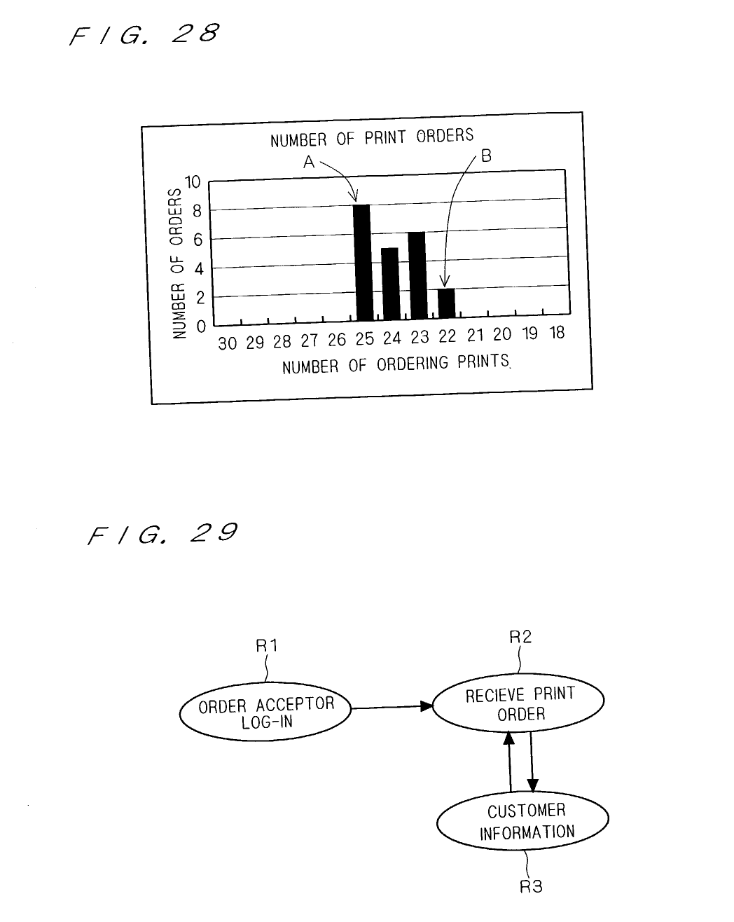

At step S41, a histogram which represents, for example, the relationship between the number of ordering prints and the number of orders shown in FIG. 28 is formed.

At step S42, the number of provisionary assigned prints is substituted into the rest of the prints to be assigned.

At step S43, a check is made to find the number of ordering prints A which does not exceed the number of the rest of the prints to be assigned and is closest thereto. For example, in the case when the number of the rest of the prints to be assigned is 100, the number of ordering prints A is 25 in the example shown in FIG. 28.

At step S44, it is determined whether or not the rest of the prints to be assigned is smaller than (the number of ordering prints A)×(the number of orders A). Here, if this is smaller, the sequence proceeds to step S45, while, if this is not smaller, the sequence proceeds to step S46.

At step S45, prints the number of which corresponds to “the rest of the prints to be assigned/the number of ordering prints A (with decimals being omitted)” of the number of ordering prints A are ordered.

At step S46, all the ordering prints A are ordered.

At step S47, the number obtained by subtracting the sum total of the prints ordered from the number of provisionary assigned prints is substituted to the number of the rest of the prints to be assigned.

At step S48, it is determined whether or not the rest of the prints to be assigned is not more than the minimum value B of the ordering prints. In the example shown in FIG. 28, the minimum value of the number of ordering prints is 22. Here, in the case when the rest of the prints to be assigned is not more than the minimum value B of the number of ordering prints, the sequence proceeds to step S49, while, if this is more than the minimum value B, the sequence returns to step S43.

At step S49, it is determined whether or not the sum total of the ordered prints is smaller than the lower limit of the number of ordered prints in each of the distributors. The lower limit of the number of ordered prints of each distributor is obtained from the lower limit data of the number of ordered prints that has been set in the print shop managing screen M6. Here, if the sum total of ordered prints is smaller than the lower limit of the number of ordered prints, the sequence proceeds to step S50, while, if not, the sequence proceeds to step S53.

At step S50, one order corresponding to the minimum value B of the ordered prints is placed.

At step S51, it is determined as to whether or not the sum total of the ordered prints is greater than the upper limit of the number of ordered prints in each of the distributors. The upper limit of the number of ordered prints of each distributor is obtained from the upper limit data of the ordered prints that has been set in the print shop managing screen M6. Here, if the sum total of ordered prints is greater than the upper limit of the number of ordered prints, the sequence proceeds to step S52, while, if not, the sequence proceeds to step S53.

At step S52, 0 is substituted to the actual number of assigned prints. This is because, since the number of ordering prints is not located between the upper limit of the number of ordered prints and the lower limit of the number of ordered prints, it is not possible to place an order to any distributors.

At step S53, the number obtained by subtracting the sum total of the ordered prints from the number of provisionary assigned prints is substituted to the actual number of the assigned prints.

### Operation of Order Acceptors

The acceptor of ordered prints (each of the distributors) carries out inputting operations to computer 3 to access the Web Photo Site of server 5, and accepts an order of distributed silver halide prints.

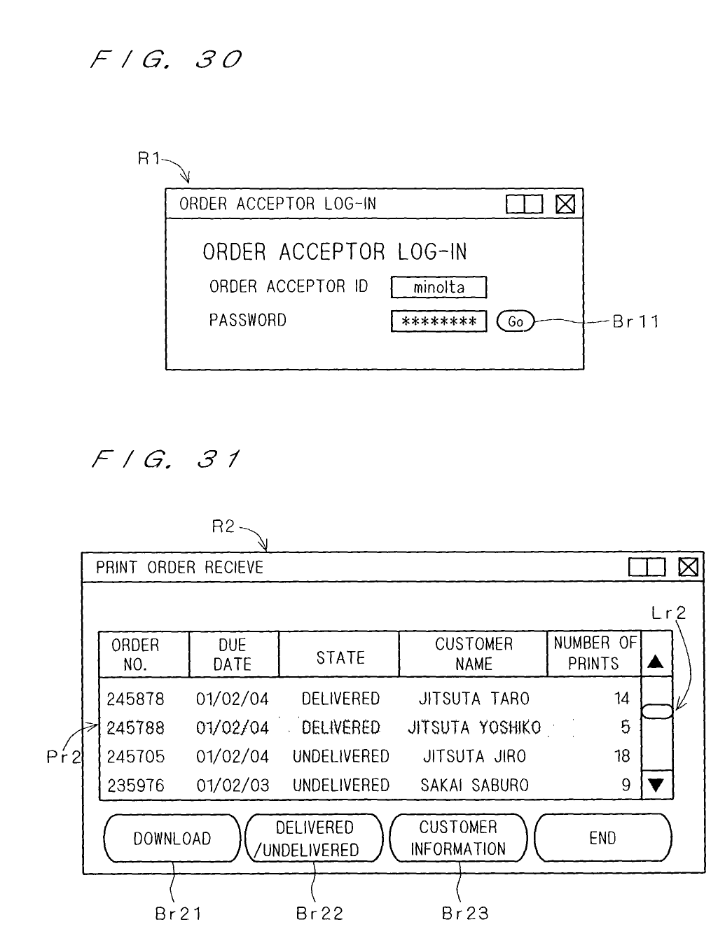

FIG. 29 is a view that explains changes in the screen displayed on computer 3 of the order acceptor. The following description will discuss respective screens R1 to R3 displayed on computer 3

(1) Order-acceptor Log-in Screen

FIG. 30 is a view that shows an order-acceptor log-in screen R1.

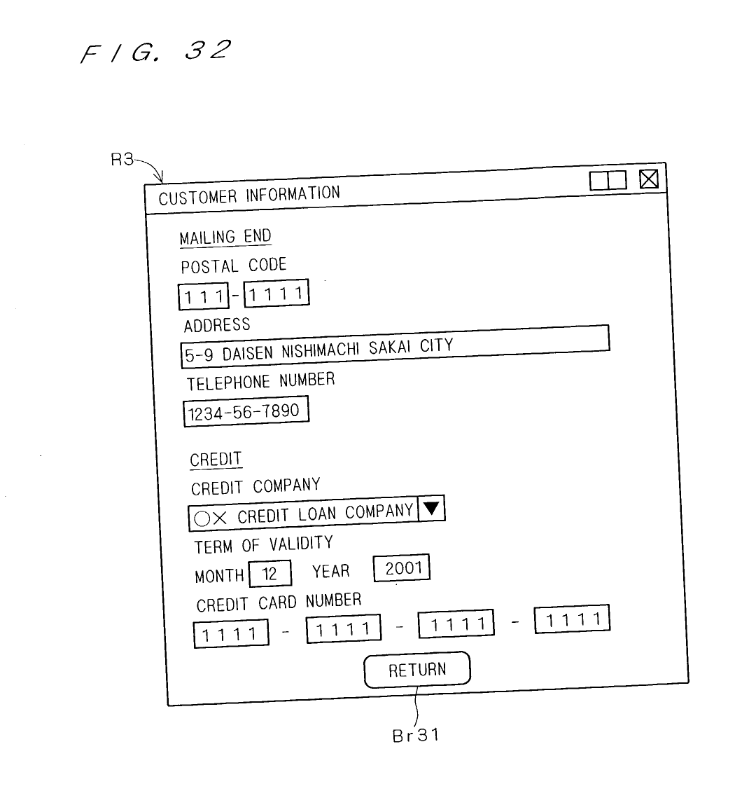

When the order-acceptor inputs a print order-acceptor URL to access the Web Photo Site through a Web browser of computer 3, the initial screen requests inputs of the order-acceptor ID and password. When, after inputting the order-acceptor ID and password, the order-acceptor selects a “Go” button Br11, the screen changes to a print order-receiving screen R2 (FIG. 31).

(2) Print Order-receiving Screen

FIG. 31 is a view that shows a print order-receiving screen R2.

Print order-receiving screen R2 displays currently ordered jobs as a list Lr2.

Print job Pr2 is selected from list Lr2, and “down load” button Br21 is selected so as to specify a storing end of the photograph image data of a customer; thus, the photograph image data is saved in the specified storing end.

After forming silver halide prints of the photograph images, the order-acceptor mails the prints to the ordering person, and upon completion of this mailing job, in order to register the completion of the print job, the order-acceptor selects the print job from list Lr2, and selects “delivered/undelivered” button Br22. Thus, the state of the print job is altered to “delivered”, and the completion of the print job is registered. Here, in the case when an attempt is made to return the state of the print job from “delivered” to “undelivered” in the event of any trouble, the print job to be returned is selected from list Lr2 and “delivered/undelivered” button Br22 is selected again.

When the print job is selected from list Lr2 and “customer information” button Br23 is then selected, a “customer information” dialogue box R3 (FIG. 32) appears to display the customer information. When “return” button Br31 of dialogue box R3 is selected, dialogue box R3 disappears to return to print order receiving screen R2.

The above-mentioned operation of electronic commerce system 1 makes it possible to distribute the print orders in accordance with sales conditions of digital cameras in distributors; thus, it becomes possible to distribute the received print orders to the respective distributors while alleviating repulsive feelings from the distributors.

Moreover, even in the case when a maker newly enters the business by adopting electronic commerce system 1, no investments are required for physical distribution centers and sales centers so that it is possible to set the break-even point of the EC site in a low level.

Furthermore, by consigning jobs obtained through the EC site to distributors, the distributors are allowed to make profits by expanding the conventional business in the amount and utilizing preliminarily capabilities, without the necessity of great investments such as facility investments. The maker is allowed to promote sales of the products without the necessity of initial investments that have been conventionally required on an incentive basis by distributing jobs obtained through the EC site.

### Modified Examples

With respect to points given to distributors in the above-mentioned preferred embodiment, the addition thereof may be carried out as follows:

In each distributor, points may be added based upon the maker's products and the areas and places of the advertising media. For example, if the maker's products are displayed on the middle area of a show window, 1000 plus points may be added in comparison with the lower or upper area thereof. In other words, a weighting process is carried out with respect to the degree of efforts of each distributor given to the maker's products such as digital cameras so that the amount of distribution of print orders may be set.

Points may be added depending on areas where distributors are located. For example, if the corresponding area is a highly competitive area on sales, addition points may be given with a 50% increase. In other words, a weighting process is carried out depending on sales areas of distributors so that the amount of distribution of print orders may be set.

The distribution of jobs to distributors may be carried out in the following manner.

Only the kinds of jobs selected by each distributor are distributed thereto. For example, with respect to those distributors which deal with jobs for putting photographs into frames or print jobs for certificate-use photographs, only the jobs selected by those distributors are distributed thereto.

With respect to jobs having short delivery time, required addition points may be set smaller, or in contrast, addition points may be given to the corresponding distributor. Thus, it becomes possible to smoothly distribute those jobs having short delivery time more smoothly.

With respect to photograph images in the above-mentioned preferred embodiment, the user does not necessarily have to upload them to the Web Photo Site, he or she may transmit only formal information such as storing places and sizes of image data, and the image data itself may be stored in the computer of the user. In this case, when the distributor prints the corresponding photograph images, it acquires the image data stored in the computer of the user. This arrangement makes it possible to reduce the burden of storing image data that is imposed on the Web Photo Site server.

Moreover, in the above-mentioned preferred embodiments, explanations have been given by exemplifying “camera distributors”; however, the scope to which the present invention is applied is not limited to the “camera distributors”. Consequently, “commodities” are not limited to only cameras and prints.

While the invention has been described in detail, the foregoing description is in all aspects illustrative and not restrictive. It is understood that numerous other modifications and variations can be devised without departing from the scope of the invention.

What is claimed is:

1. An electronic commerce system which has a group of information processing elements including a computer for placing orders of objective commodities and an order managing device for retrieving and managing said orders, said group of information processing elements being mutually connected through a network, said group of information processing elements comprising:
(a) a sales managing element for managing sales information of reference commodities different from said objective commodities in a plurality of distributors selling said reference commodities;
(b) a setting element for setting allocation of orders among said plurality of distributors in accordance with the sales information of said reference commodities; and
(c) a sharing element which shares respective orders of said objective commodities received by said order managing device among said plurality of distributors based upon said allocation.

2. The electronic commerce system according to claim 1, wherein
said reference commodities include plural kinds of commodities, and
said setting element is operable to set said allocation at different weights with respect to said plural kinds of commodities.

3. The electronic commerce system according to claim 1, wherein
said setting element is operable to set said allocation in response to sales efforts of said reference commodities in said plurality of distributors.

4. The electronic commerce system according to claim 1, wherein
said setting element is operable to set said allocation in response to sales areas of said reference commodities covered by said plurality of distributors.

5. The electronic commerce system according to claim 1, wherein
respective maximum limits of receiving orders are previously determined in said plurality of distributors, and
said sharing element is operable to limit shares of respective orders of said objective commodities among said plurality of distributors by said respective maximum limits.

6. The electronic commerce system according to claim 1, wherein
respective minimum limits of receiving orders are previously determined in said plurality of distributors, and
said sharing element is operable to inhibit sharing of said respective orders less than said respective minimum limits of respective distributors.

7. The electronic commerce system according to claim 1, wherein
said respective orders are directed to print service relating to image data.

8. An order receiving and placing system for commodities, comprising:
(a) an order-receiving element for receiving orders of first commodities;
(b) a sales managing element for managing sale record of second commodities in a plurality of distributors;
(c) a determination element for determining respective shares of said orders of said first commodities among said plurality of distributors in accordance with said sales record of said second commodities; and
(d) an ordering element which places said orders of said first commodities to said plurality of distributors in accordance with said shares.

9. The order receiving and placing system according to claim 8, wherein
said second commodities include plural kinds of commodities, and
said determination element is operable to determine said shares at different weights with respect to said plural kinds of commodities.

10. The order receiving and placing system according to claim 8, wherein
said setting element is operable to determine said shares in response to sales efforts of said second commodities in said plurality of distributors.

11. The order receiving and placing system according to claim 8, wherein
said setting element is operable to determine said shares in response to sales areas of said second commodities covered by said plurality of distributors.

12. The order receiving and placing system according to claim 8, wherein
respective maximum limits of receiving orders are previously determined in said plurality of distributors, and
said determination element is operable to limit shares of respective orders of said first commodities among said plurality of distributors by said respective maximum limits.

13. The order receiving and placing system according to claim 8, wherein
respective minimum limits of receiving orders are previously determined in said plurality of distributors, and
said determination element is operable to inhibit sharing of said respective orders less than said respective minimum limits of respective distributors.

14. An order managing device for conducting management with respect to orders of first commodities transmitted from order-reception computers, said order managing device comprising:
(a) a sales managing element for managing sales information of reference commodities different from said objective commodities in a plurality of distributors selling said reference commodities;
(b) a setting element for setting allocation of orders among said plurality of distributors in accordance with the sales information of said reference commodities; and
(c) a sharing element which shares respective orders of said objective commodities received by said order managing device among said plurality of distributors based upon said allocation.

15. The order managing device according to claim 14, wherein
said reference commodities include plural kinds of commodities, and
said setting element is operable to set said allocation at different weights with respect to said plural kinds of commodities.

16. The order managing device according to claim 14, wherein
said setting element is operable to set said allocation in response to sales efforts of said reference commodities in said plurality of distributors.

17. The order managing device according to claim 14, wherein
said setting element is operable to set said allocation in response to sales areas of said reference commodities covered by said plurality of distributors.

18. The order managing device according to claim 14, wherein
respective maximum limits of receiving orders are previously determined in said plurality of distributors, and
said sharing element is operable to limit shares of respective orders of said objective commodities among said plurality of distributors by said respective maximum limits.

19. The order managing device according to claim 14, wherein
respective minimum limits of receiving orders are previously determined in said plurality of distributors, and
said sharing element is operable to inhibit sharing of said respective orders less than said respective minimum limits of respective distributors.

20. A recording medium which has a program recorded therein that is readable by a computer installed in an order managing device, said program, installed in said computer, allowing said order managing device to execute the steps of:
(a) managing sales information of reference commodities different from said objective commodities in a plurality of distributors selling said reference commodities;
(b) setting allocation of orders among said plurality of distributors in accordance with the sales information of said reference commodities; and
(c) sharing respective orders of said objective commodities received by said order managing device among said plurality of distributors based upon said allocation.

21. A method of managing orders of objective commodities in an electronic commerce system including computers for placing orders of a commodity and an order managing device coupled to said computers, comprising the steps of:
(a) managing sales information of reference commodities different from said objective commodities in a plurality of distributors selling said reference commodities;
(b) setting allocation of orders among said plurality of distributors in accordance with the sales information of said reference commodities; and
(c) sharing respective orders of said objective commodities received by said order managing device among said plurality of distributors based upon said allocation.
